(19) United States
(12) Patent Application Publication
(10) Pub. No.: US 2004/0131856 A1
(43) Pub. Date: Jul. 8, 2004

(54) Alpha-alumina powder and method of producing the same

(75) Inventors: Kazuhisa Kajihara, Niihama-shi (JP); Yoshiaki Takeuchi, Niihama-shi (JP); Toshifumi Katsuda, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/671,727

(22) Filed: Sep. 29, 2003

(30) Foreign Application Priority Data
Oct. 2, 2002 (JP) 2002-289626

(51) Int. Cl. B32B 5/16

(52) U.S. Cl. 428/407; 428/402

(57) ABSTRACT

An α-alumina powder suitably used as an additive to a magnetic recording medium and a method of producing the same are described. An α-alumina powder wherein the average primary particle diameter is 10 to 100 nm, the content of an a phase represented by the following formula:

I₍₁₁₃₎/(I₍₁₁₃₎+I₍₂₀₀₎) (1)

[wherein, I₍₁₁₃₎ represents the peak intensity of a (113) plane of α-alumina in an X-ray diffraction spectrum, and I₍₂₀₀₎ represents the peak intensity of a (200) plane of θ alumina in an X-ray diffraction spectrum] is 90% or more, at least one first component selected from silicon, zirconium, phosphorus and boron is contained in an amount of 0.1 to 10 wt % in terms of oxide, and at least one second component selected titanium, iron and chromium is contained in an amount of 0.1 to 30 wt % in terms of oxide.

### BACKGROUND OF THE INVENTION

1. Field of the Invention

The present invention relates to an α-alumina powder and a method of producing the same, more specifically, to an α-alumina powder suitably used as an additive to a magnetic recording medium and a method of producing the same.

2. Description of Related Art

α-alumina is used as an additive to magnetic recording media. In this application, it is usual that a magnetic powder and a polishing material such as α-alumina and the like are dispersed together with a binder such as a vinyl chloride resin, urethane resin and the like in an organic solvent to provide a coating agent, this coating agent is applied on a base material of a magnetic medium, and dried to form a magnetic layer. Recently, with decrease in thickness of a magnetic layer, finer α-alumina is desired. As the method of producing finer α-alumina, there is, for example, a method of calcining an aluminum-containing substance at low temperatures. Further, there is known a method of calcining an aluminum-containing substance in the presence of a silicon compound (Japanese Patent Application Laid-Open No. 5-345611).

α-alumina obtained by conventional method does not have sufficient dispersibility in an organic solvent of coating agent used for formation of a magnetic layer.

### BRIEF SUMMARY OF THE INVENTION

The present inventors have studied a method of producing a fine α-alumina powder having good dispersibility in an organic solvent, and resultantly lead to completion of the present invention.

The present invention provides an α-alumina powder wherein the average primary particle diameter is 10 to 100 nm, the content of an α phase represented by the following formula:

I₍₁₁₃₎/(I₍₁₁₃₎+I₍₂₀₀₎) (1)

[wherein, I₍₁₁₃₎ represents the peak intensity of a (113) plane of α-alumina in an X-ray diffraction spectrum, and I₍₂₀₀₎ represents the peak intensity of a (200) plane of θ-alumina in an X-ray diffraction spectrum] is 90% or more, at least one first component selected from silicon, zirconium, phosphorus and boron is contained in an amount of 0.1 to 10 wt % in terms of oxide, and at least one second component selected titanium, iron and chromium is contained in an amount of 0.1 to 30 wt % in terms of oxide.

Further, the present invention provides a method of producing an α-alumina powder comprising calcining a mixture containing an aluminum-containing substance, particle growth retarder and seed crystal in an atmosphere of a partial pressure of water vapor of 600 Pa or less.

### DETAIED DESCRITION OF THE INVENTION

The α-alumina powder of the present invention is a compound of formula Al₂O₃, and is mainly composed of a component having a phase, further, comprises a first component selected from silicon, zirconium, phosphorus and boron and a second component selected from titanium, iron and chromium.

As the first component, at least one selected from silicon, zirconium, phosphorus and boron may be contained advantageously, and two or more of them may also be contained. The content of the first component is 0.1 wt % or more, preferably 0.2 wt % or more and 10 wt % or less, preferably 3 wt % or less in terms of oxide, namely, in terms of weight of SiO₂, ZrO₂, P₂O₅ and B₂O₃ based on the α-alumina powder of the present invention. When two or more first components are contained, the total amount of them may be advantageously in this range. When the amount of these first components is too small, the size particles of the α-alumina powder increases, or the smoothness of a magnetic layer formed by using coating agent obtained by mixing an α-alumina powder and an organic solvent decreases, in some cases. On the other hand, when the amount is too large, an α-alumina powder tends to be coagulated in an organic solvent, and dispersibility thereof decreases, in some cases.

Likewise, as the second component, at least one selected from titanium, iron and chromium may be contained advantageously, and two or more of them may also be contained. The content of the second component is 0.1 wt % or more, preferably 1 wt % or more and 30 wt % or less, preferably 20 wt % or less in terms of oxide, namely, in terms of weight of TiO₂, Fe₂O₃ and Cr₂O₃ based on the α-alumina powder of the present invention. When two or more second components are contained, the total amount of them may be advantageously in this range. When the amount of these second components is too small, the temperature to transform an aluminum-containing substance to α-alumina is not decreased and calcination at higher temperatures is necessary, and α-alumina particles strongly agglomerate, resultantly dispersibility of an α-alumina powder in an organic solvent decreases, in some cases. The content of any of silicon, zirconium boron, titanium, iron and chromium in an α-alumina powder can be measured by a mass spectrometry method.

The α-alumina powder of the present invention has an average primary particle diameter of 10 nm or more, preferably 20 nm or more and 100 nm or less, preferably 50 nm or less. In the case of an α-alumina powder having small average primary particle diameter, dispersibility in an organic solvent decreases. On the other hand, in the case of an α-alumina powder having large average primary particle diameter, even if a magnetic layer can be formed using coating agent with the α-alumina powder, that having an excellent magnetic property and electromagnetic conversion characteristics cannot be obtained.

In the α-alumina powder of the present invention, a content of an α phase is 90% or more, preferably 95% or more. An α-alumina powder having a content of an a phase of less than 90% does not have sufficient dispersibility in an organic solvent, and after dispersing treatment, coating agent is thickened in some cases. The content of an a phase can be obtained by measuring the peak intensity I₍₁₁₃₎ of a (113) plane of α-alumina and the peak intensity I₍₂₀₀₎ of a (200) plane of θ-alumina (transition alumina having θ phase) in an X-ray diffraction spectrum, and calculating according to the above-mentioned formula (1).

The α-alumina powder of the present invention preferably has a BET specific surface area of 20 m²/g or more.

The α-alumina powder of the present invention usually has particle shape not of regular polyhedron such as regular octahedron, and has particle surfaces constituted of at least three, preferably five or more planes (about 30 or more) having different areas.

By calcining a mixture containing an aluminum-containing substance, particle growth retarder and seed crystal in an atmosphere in which the partial pressure of water vapor of 600 Pa or less is controlled, an α-alumina powder can be produced having average primary particle diameter in the suitable range and excellent in dispersibility in an organic solvent. Further, when a silicon compound, zirconium compound, phosphorus compound or boron compound is used as the particle growth retarder and a titanium compound, iron compound and/or chromium compound is used as the seed crystal, an α-alumina powder containing the above-mentioned first component and second component and excellent in dispersibility can be obtained.

By using a specific aluminum compound, namely, α-alumina, aluminum nitride, aluminum carbide or diaspore as the seed crystal, an α-alumina powder more excellent in dispersibility in an organic solvent can be obtained.

The aluminum-containing substance used in production of an α-alumina powder may advantageously be, for example, that turns into α-alumina by calcining in air of 1000° C. or more, and listed are transition alumina having γ, χ, θ, δ, ρ or κ phase, amorphous alumina, aluminum hydroxide having gibbsite, boehmite, pseudo-boehmite, bayerite or norstrandite crystal phase, amorphous aluminum hydroxide, aluminum oxalate, aluminum acetate, aluminum stearate, ammonium alum, aluminum lactate, aluminum laurate, aluminum ammonium carbonate, aluminum sulfate, aluminum ammonium sulfate, aluminum nitrate or ammonium aluminum nitrate and the like. These may be used each singly or in combination of two or more. Of them, transition alumina or aluminum hydroxide is preferable.

The particle growth retarder has an action of controlling particle growth of α-alumina in calcination to provide fine particles. The particle growth retarder is preferably, in view of dispersibility of the resultant α-alumina powder, a silicon compound, zirconium compound, phosphorus compound or boron compound. Examples of the silicon compound include silicon oxide [SiO₂], silicon nitride [Si₃N₄], silicon carbide [SiC], silicon borides [SiB₃, SiB₆], silicon halides [silicon tetrachloride, trichlorosilane, methyldichlorosilane], liquid silicone, alkyl silicates [tetramethyl silicate, tetraethyl silicate], aminosilanes [aminomethyltriethoxysilane, di (aminomethyl) diethoxysilane, γ-aminopropyltrimethoxysilane, γ-aminopropyltriethoxysilane] and the like. Examples of the zirconium compound include zirconium oxide [ZrO₂], zirconium nitride [ZrN], zirconium carbide [ZrC], zirconium boride [ZrB₂], zirconium halides [zirconium oxychloride, zirconium tetrachloride], zirconium nitrate [Zr(NO₃)₂], zirconium carbonate [ZrCO₃], zirconiumsulfate [ZrSO₄], zirconiumalkoxides [zirconium ethoxide, zirconium butoxide, tetraisopropoxide zirconium], zirconium hydroxycarboxylate [Zr(OH)₂C₂O₄], dichlorobis (dimethylamie) zirconium [ZrCl₂ [N(CH₃)₂]₂] and the like. Examples of the phosphorus compound include phosphorus oxides [PO₃, P₂O₅], phosphorus halide [PCl₃], phosphoric acid [H₃PO₄], phosphorous acid [H₂PHO₃], hypophosphorous acid [HPH₂O₂], polyphosphoric acids [H₄P₂O₇, H₅P₃O₁₀, H₆P₄O₁₃], metaphosphoric acid [(HPO₃)ₙ], phosphates [(NH₄)₃PO₄, (NH₄)₂HPO₄, NH₄H₂PO₄], alkyl phosphates [C₆H₁₅O₄P, C₁₂H₂₇O₄P], phosphines [P(CH₃)₃, P(C₆H₅)₃, (C₆H₅)₃PO] and the like. Examples of the boron compound include boron oxide [B₂O₃], boron nitride [BN], boron carbide [B₄C], boric acids [HBO₂, H₃BO₃], ammonium borates [NH₄BO₂, (NH₄)₂B₄O₇, NH₄B₅O₈], boron halides [BBr₃, BCl₃], trialkoxyboranes [trimethoxyborane], amineboranes [(CH₃)₂NHBH₃], aminoboranes [(CH₃)₂NBH₂] and the like. These also can be used each singly or in combination of two or more. Of them, silicon compounds are preferable, and more preferable are silicon oxide, tetramethyl silicate, tetraethyl silicate, aminomethyltriethoxysilane, di(aminomethyl)diethoxysilane, γ-aminopropytrimethoxysilane and γ-aminopropytriethoxysilane.

When a solid particle growth retarder is used, its average particle diameter is preferably 1 μm or less, more preferably 0.1 μm or less. The amount of the particle growth retarder is usually 0.1 wt % or more, preferably. 0.2 wt % or more and usually 10 wt % or less, preferably 3 wt % or less in terms of oxide, based on the α-alumina powder obtained by calcination.

The seed crystal mixed with the aluminum-containing substance and particle growth retarder is preferably a titanium compound, iron compound, chromium compound or aluminum compound from the standpoint of dispersibility. Examples of the titanium compound include titanium oxide [TiO₂], titanium nitride [TiN], titanium carbide [TiC], titanium boride [TiB₂] and the like. Examples of the iron compound include iron oxide [Fe₃O₄], iron nitrides [FeN, Fe₃N, Fe₄N, Fe₁₆N₂], iron carbides [Fe₂C, Fe₅C₂, Fe₃C], iron borides [Fe₂B, FeB, FeB₂] and the like. Examples of the chromium compound include chromium oxide [Cr₂O₃], chromium nitrides [Cr₂N, CrN], chromium carbides [Cr₄C, Cr₃C₂, Cr₇C₃], chromium borides [Cr₄B, Cr₂B, Cr₃B₂, CrB, CrB₂] and the like. Examples of the aluminum compound include α-alumina [Al₂O₃], aluminum nitride [AlN], aluminum carbide [Al₄C₃] or diaspore [AlOOH]. These seed crystals may also be used each singly or in combination of two or more. Of them, titanium oxide, iron oxide, chromium oxide or α-alumina, diaspore are preferable, and titanium oxide is more preferable. The amount of the seed crystal is usually 0.1 wt % or more, preferably 1 wt % or more and usually 30 wt % or less, preferably 20 wt % or less in terms of oxide based on the α-alumina powder obtained by calcination.

Mixing of an aluminum-containing substance, particle growth retarder and seed crystal can be conducted usually using a ball mill, vibration mill, dyno mill, vertical granulator, Henschel mixer and the like. Mixing may be conducted under dry conditions or wet conditions.

Calcination of a mixture is conducted in an atmosphere in which the partial pressure of water vapor is controlled, and usually conducted in an atmosphere in which the partial pressure of water vapor of 600 Pa or less (dew point of 0° C. or lower in the case of a gas having a total pressure of 1 atom). The lower partial pressure of water vapor in the calcination atmosphere is preferable, and it is preferable 165 Pa or lower (dew point is −15° C. or lower in the case of a gas having a total pressure of 1 atom), more preferably 40 Pa or less (dew point of −30° C. or lower in the case of a gas having a total pressure is 1 atom).

The calcination may be conducted by an apparatus by which the atmosphere can be controlled to a partial pressure of water vapor of 600 Pa or lower, for example, can be conducted by discharging a gas out of a furnace or introducing a gas into a furnace using a calcination furnace such as a tubular type electric furnace, box type electric furnace, tunnel furnace, far infrared furnace, micro wave heating furnace, shaft kiln, reflection kiln, rotary kiln, roller hearth kiln and the like. In calcination, when an aluminum-containing substance generating little water vapor such as transition alumina is used as a raw material, calcination can be conducted by charging an aluminum-containing substance in a vessel and introducing dry air having a partial pressure of water vapor of 600 Pa or lower before sealing the vessel. Calcination may be conducted under reduced pressure when the atmosphere having a partial pressure of water vapor of 600 Pa or lower, for example, can be conducted under a pressure-reduced atmosphere having a total pressure of 600 Pa or lower composed of a gas such as air, hydrogen, helium, nitrogen and argon. The calcination furnace used in this operation may be of batch-wise or continuous.

Calcination may be conducted at a temperature necessary for phase transformation from an aluminum-containing substance to α-alumina, and the temperature is about 900° C. or higher, preferably about 1000° C. or higher, and about 1250° C. or lower, preferably about 1200° C. or lower. The calcination time differs depending on the kind of a calcination furnace used and the calcination temperature, and usually about 10 minutes or longer, preferably about 30 minutes or longer, and about 12 hours or less.

As the gas introduced into a furnace, those having controlled a partial pressure of water vapor are preferably used, and for example, there are preferably used dry air obtained by compressing air by a compressor to condense moisture contained in air, separating this condensed moisture, then, reducing the pressure, dry air obtained by removing moisture from air by a dehumidifier, dry nitrogen obtained by evaporating liquid nitrogen, and the like. A commercially available cylinder filled with air, helium, nitrogen and the like can be used providing no moisture is contained.

An α-alumina powder obtained by calcination is usually used itself of ground before use. Grinding can be conducted in a vibration mill, ball mill, jet mill and the like. On the α-alumina powder, particle size control such as classification may be conducted. Classification can be conducted by using a sieve, cyclone and the like, and may be conducted under dry conditions or wet conditions.

The α-alumina powder of the present invention thus obtained has excellent dispersibility in an organic solvent irrespective of small average primary particle diameter, therefore, is suitably used as an additive to magnetic media such as magnetic tapes for a broadcasting station such as DVCPRO, HDCAM, β cam, digital β cam and the like, magnetic tapes for mass data storage called DDS-2, DDS-3, DDS-4, D8, DLT, S-DLT, LTO, DTF, SD1, IBM3590 and the like. This α-alumina powder can also be mixed with an aqueous solvent to provide a water slurry. Moreover, this α-alumina powder can be suitably used as raw material for production of various ceramics such as a sintered body, an abrasive, a toner additive, a resin fillers, in addition to the above-mentioned application for magnetic recording media.

### EXAMPLES

The present invention will be illustrated further in detail by the following examples, but the scope of the invention is not limited to these examples. The average primary particle diameter of an α-alumina powder, content of an a phase, and BET specific surface area, were measured according to the following methods.

Average Primary Particle Diameter (nm):

A sample was photographed using a transmission electron microscope (trade name: “H-7000”, manufactured by Hitachi Ltd.), the primary particle diameter of each of 20 or more any particles in this photo was measured, and the average value of the measured values was an average primary particle diameter. Content of α Phase (%):

An X-ray diffraction spectrum of a sample was measured by using an X-ray diffractometer (trade name “Rint-2100” manufactured by Rigaku Denki K. K.), and the peak intensity I₍₁₁₃₎ of a (113) plane of a alumina in the diffraction spectrum and the peak intensity I₍₂₀₀₎ of a (200) plane of θ alumina in the diffraction spectrum were measured, and the content of an α phase was calculated according to the above-mentioned formula (1).

BET Specific Surface Area (m²/g)

It was measured by a nitrogen adsorption method using specific surface area measuring apparatus (trade name “FLOWSORP II2300”, manufactured by Shimadzu Corp.).

### Example 1

[Production of α-alumina Powder]

A water slurry prepared by dispersing 115 parts by weight of aluminum hydroxide (crystal phase: pseudo-boehmite, 78 wt % as Al₂O₃) obtained by hydrolysis of aluminum isopropoxide and 10 parts by weight of titanium oxide (trade name “TT055N”, manufactured by Ishihara Sangyo Co. Ltd.) in 40 parts by weight of water, and an aqueous solution prepared by dissolving 2.2 parts by weight of γ-aminopropyltriethoxysilane (trade name “A-1100”, manufactured by Nippon Unicar Co. Ltd.) in 70 parts by weight of water were charged into a super mixer sequentially, and they were mixed at 600 rpm for 20 minutes. This mixture was dried, then, charged into a tubular type electric furnace having an inner volume of 8 L (manufactured by Motoyama K. K.). Dry air having a dew point of −15° C. (partial pressure of water vapor: 165 Pa) was introduced into the furnace at a rate of 1 L/minute and the powder was heated up to 1080° C. and this temperature was maintained for 3 hours while maintaining the dew point of the atmosphere in the furnace at −15° C., then, calcined product was gradually cooled. This calcined product was ground in a vibration mill (medium: alumina balls having a diameter of 15 mm), to obtain an α-alumina powder. This α-alumina powder had a SiO₂ content of 0.6 wt %, a TiO₂ content of 10 wt %, and an average primary particle diameter of 50 nm, a content of an a phase of 100%, and a BET specific surface area of 30 m²/g.

[Evaluation of Dispersibility of α Alumina Powder]

30 wt % of obtained α-alumina powder, 2.4 wt % of a vinyl chloride resin (trade name “R110”, manufactured by Nippon Zeon Co. Ltd.), 40.6 wt % of methyl ethyl ketone (manufactured by Wako Pure Chemical Industries Ltd.) and 27 wt % of cyclohexanone (manufactured by Wako Pure Chemical Industries Ltd.) were mixed. Obtained mixture was dispersed for 4 hours in a batch-wise sand grinder (“4TSG-⅛”, content volume; 0.5 L, medium: glass beads having a diameter of 2 mm, stirring rate: 2000 rpm, manufactured by Igarashi Kikai Seizou K. K.) to obtain a coating agent. This coating agent was applied on a polyethylene terephthalate film having thickness of 14 μm using a doctor blade (clearance between film and blade: 45 μm) and dried to form a layer having a length of 200 mm and a width of 60 mm. On this layer, 45° mirror surface glossiness against the length direction of the layer was measured using a glossmeter (trade name “VG-1D”, manufactured by Nippon Denshoku Kogyo K. K.) according to JIS-Z8741. Larger value of this 45° mirror surface glossiness indicates more uniform dispersion of α-alumina in the layer. The 45° mirror surface glossiness was 52%.

### Comparative Example 1

115 parts by weight of aluminum hydroxide (crystal phase: pseudo-boehmite, 78 wt % as Al₂O₃) obtained by hydrolysis of aluminum isopropoxide and an aqueous solution prepared by dissolving 4.4 parts by weight of γ-aminopropyltriethoxysilane (trade name “A-1100”, manufactured by Nippon Unicar Co. ltd.) in 70 parts by weight of water were charged into a super mixer sequentially and mixed. This mixture was dried, then, charged into a tubular type electric furnace having an-inner volume of 8 L (manufactured by Motoyama K. K.). Air having a dew point of +20° C. (partial pressure of water vapor: 2300 Pa) was introduced into the furnace at a rate of 1 L/minute and the powder was heated up to 1230° C. and this temperature was maintained for 3 hours while maintaining the dew point of the atmosphere in the furnace at +20° C., then, calcined product was gradually cooled. This calcined product was ground in a vibration mill (medium: alumina balls having a diameter of 15 mm), to obtain an a alumina powder. This α alumina powder had a SiO₂ content of 1.2 wt %, an average primary particle diameter of 50 nm, a content of an a phase of 100%, a BET specific surface area of 30 m²/g, and a content of zirconium, boron, titanium, iron and chromium of each less than 0.01 wt %. This α-alumina powder was evaluated in the same condition as in [Evaluation of dispersibility of α-alumina powder] in Example 1. In this example, the 45° mirror surface glossiness was 5%.

The α-alumina powder of the present invention has small average primary particle diameter, and has excellent dispersibility in an organic solvent. According to the production method of the present invention, such an α-alumina powder can be obtained easily.

What is claimed is:

1. An α-alumina powder wherein the average primary particle diameter is 10 to 100 nm, the content of an a phase represented by the following formula:
I₍₁₁₃₎/I₍₁₁₃₎+I₍₂₀₀₎) (1)
[wherein, I₍₁₁₃₎ represents the peak intensity of a (113) plane of α-alumina in an X-ray diffraction spectrum, and I₍₂₀₀₎ represents the peak intensity of a (200) plane of θ-alumina in an X-ray diffraction spectrum] is 90% or more, at least one first component selected from silicon, zirconium, phosphorus and boron is contained in an amount of 0.1 to 10 wt % in terms of oxide, and at least one second component selected titanium, iron and chromium is contained in an amount of 0.1 to 30 wt % in terms of oxide.

2. The α-alumina powder according to claim 1 wherein, further, the BET specific surface area is 20 m²/g or more.

3. The α-alumina powder according to claim 1 wherein the average primary particle diameter is 20 to 50 nm.

4. The α-alumina powder according to claim 1 wherein the content of an a phase is 95% or more.

5. A method of producing an α-alumina powder comprising calcining a mixture containing an aluminum-containing substance, particle growth retarder and seed crystal in an atmosphere of a partial pressure of water vapor of 600 Pa or less.

6. The method according to claim 5 wherein the aluminum-containing substance is selected from transition alumina, amorphous alumina, aluminum hydroxide, amorphous aluminum hydroxide, aluminum oxalate, aluminum acetate, aluminum stearate, ammonium alum, aluminum lactate, aluminum laurate, aluminum ammonium carbonate, aluminum sulfate, aluminum ammonium sulfate, aluminum nitrate and aluminum ammonium nitrate.

7. The method according to claim 5 wherein the aluminum-containing substance is transition alumina or aluminum hydroxide.

8. The method according to claim 5 wherein the particle growth retarder is selected from silicon compounds, zirconium compounds, phosphorus compounds and boron compounds.

9. The method according to claim 8 wherein the silicon compound is selected from silicon oxide, tetramethyl silicate, tetraethyl silicate, aminomethyltriethoxysilane, di (aminomethyl) diethoxysilane, γ-aminopropyltrimethoxysilane and γ-aminopropyltriethoxysilane.

10. The method according to claim 5 wherein the amount of the particle growth retarder is 0.1 to 10 wt % in terms of oxide based on the α-alumina powder obtained by calcination.

11. The method according to claim 5 wherein the seed crystal is selected from titanium compounds, iron compounds, chromium compounds, α-alumina, aluminum nitride, aluminum carbide and diaspore.

12. The method according to claim 11 wherein the titanium compound is titanium oxide, the iron compound is iron oxide, and the chromium compound is chromium oxide.

13. The method according to claim 11 wherein the seed crystal is titanium oxide.

14. The method according to claim 5 wherein the amount of the seed crystal is 0.1 to 30 wt % in terms of oxide based on the α-alumina powder obtained by calcination.

15. The method according to claim 5 wherein the partial pressure of water vapor is 165 Pa or less.
